(19) United States
(12) Patent Application Publication
(10) Pub. No.: US 2025/0315028 A1
(43) Pub. Date: Oct. 9, 2025

(54) SYSTEM AND METHOD FOR GENERATION OF SUB-SKILLS

(71) Applicant: Quantiphi, Inc, Marlborough, MA (US)

(72) Inventors: Dagnachew Birru, Marlborough, MA (US); Muneeswaran I, Mumbai (IN); Saisubramaniam Gopalakrishnan, Mumbai (IN); Kenneth Rebello, Mumbai (IN); Vishal Vaddina, Toronto (CA)

(73) Assignee: Quantiphi, Inc, Marlborough, MA (US)

(21) Appl. No.: 18/627,430

(22) Filed: Apr. 4, 2024

(51) Int. Cl. G05B 19/4155

(52) U.S. Cl. CPC G05B 19/4155; G05B 2219/31449

(57) ABSTRACT

A system for generation of a sub-skill is disclosed. The system includes a processor that is configured to: receive an input comprising goal information to achieve a first sub-skill, and requirement information to achieve the goal for the first sub-skill; generate a machine readable meta-plan based on the input. The processor is further configured to generate a first executable logic based on the generated machine readable meta-plan; and iteratively refine the generated first executable logic to obtain a refined executable logic based on a validation operation. In the validation operation, when the first executable logic is executed, an output dataset is generated and compared with an outcome specified by the goal and the requirement information such that in each iteration of the refinement of the generated first executable logic, one or more errors or inconsistencies in the first executable logic is removed.

### FIELD OF TECHNOLOGY

The present disclosure generally relates to natural language understanding and generation techniques applied in workflow automation systems. Specifically, the present disclosure relates to a system and a method for generation of an executable logic of a sub-skill.

### BACKGROUND

The domain of workflow optimization and automation is useful across various industries, aiming to streamline processes and enhance efficiency. Manual and repetitive procedures often pose challenges, being time-consuming, prone to errors, and demanding significant resources for effective management.

Existing technologies predominantly rely on conventional software solutions that necessitate users to possess coding expertise or comprehensive knowledge of intricate system operations. Such requirements often lead to diminished efficiency due to the steep learning curve and technical complexities imposed on the users. In the pursuit of addressing such challenges, the disclosed prior art primarily revolves around software solutions reliant on traditional coding methodologies. These solutions, while functional, demand a high level of technical proficiency from users, limiting accessibility and efficiency. Moreover, these systems often lack a comprehensive natural language-based interface, hindering smooth communication between users and the system.

Further limitations and disadvantages of conventional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a method and a system for generation of an executable logic of a sub-skill. The present disclosure seeks to provide a solution to the existing problem of how to efficiently and intelligently create executable logic tailored to specific sub-skills. An aim of the present disclosure is to provide a solution that overcomes at least partially the problems encountered in the prior art and provide an improved system that eliminates the requirement for extensive coding or programming experience in creating sub-skills. Additionally, the disclosure aims to offer an improved method that empowers individuals without coding expertise to generate innovative ideas for sub-skills and translate them into executable logic effectively.

In one aspect, the present disclosure provides a system comprising a processor configured to: receive an input comprising goal information to achieve a first sub-skill, and requirement information to achieve the goal for the first sub-skill; generate a machine readable meta-plan based on the input. The machine readable meta-plan is indicative of a set of sequential tasks that define a sequence of tasks and interdependencies required to accomplish a goal defined in the goal information. The processor is further configured to generate a first executable logic based on the generated machine readable meta-plan; and iteratively refine the generated first executable logic to obtain a refined executable logic based on a validation operation. In the validation operation, when the first executable logic is executed, an output dataset is generated and compared with an outcome specified by the goal and the requirement information such that in each iteration of the refinement of the generated first executable logic, one or more errors or inconsistencies in the first executable logic is removed.

Firstly, the reception of input, including goal and requirement information, lays the foundation for user-defined tasks. This user-centric approach allows the system to tailor its subsequent actions based on explicit user objectives, fostering a personalized and goal-driven workflow. The generation of a machine-readable meta-plan is a pivotal step, offering a technical advantage by encapsulating the user's goals and requirements into a structured sequence of tasks. This meta-plan serves as a dynamic blueprint, enabling the processor to comprehend and articulate the logical flow required to achieve the specified sub-skill. The machine-readable format enhances system interpretability and adaptability. Following this, the generation of the first executable logic based on the machine readable meta-plan introduces efficiency. By translating the abstract meta-plan into executable code, the system automates the initial logic creation, saving time and ensuring consistency between the user's intent and the generated logic. The iterative refinement process further refines the generated logic based on a validation operation. This iterative approach presents a technical advantage by incorporating an automated feedback loop. Each iteration refines the logic by addressing errors or inconsistencies revealed during execution, enhancing the system's self-correcting capability and improving the overall reliability of the executable logic. In the validation operation, the technical advantage lies in the system's ability to systematically evaluate the performance of the executable logic. The generation of an output dataset and its comparison against specified outcomes ensures that the logic aligns with user-defined expectations. The validation operation enhances the precision and correctness of the first executable logic, contributing to the system's robustness. Collectively, the above mentioned technical advantages illustrate a systematic and user-centric approach in the creation, refinement, and validation of executable logic, ultimately providing a tailored and reliable solution for achieving specified sub-skills.

In another aspect, the present disclosure provides a method comprising receiving, by a processor, an input comprising goal information to achieve a first sub-skill, and requirement information to achieve the goal for the first sub-skill; generating, by the processor, a machine readable meta-plan based on the input. The machine readable meta-plan is indicative of a set of sequential tasks that define a sequence of tasks and interdependencies required to accomplish a goal defined in the goal information. The method further comprises generating, by the processor, a first executable logic based on the generated machine readable meta-plan; and iteratively refining, by the processor, the generated first executable logic to obtain a refined executable logic based on a validation operation. In the validation operation, when the first executable logic is executed, an output dataset is generated and compared with an outcome specified by the goal and the requirement information such that in each iteration of the refinement of the generated first executable logic, one or more errors or inconsistencies in the first executable logic is removed.

The method achieves all the advantages and technical effects of the system of the present disclosure.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features, and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not too scaled. Wherever possible, like elements have been indicated by identical numbers.

Embodiments of the present disclosure will now be described, by way of example only, with reference to the following diagrams wherein:

FIG. 1 is a block diagram illustrating a system for generation of an executable logic of a first sub-skill, in accordance with an embodiment of the present disclosure;

FIG. 2 is a flow diagram illustrating operations of the system for generation of the executable logic of the first sub-skill, in accordance with an embodiment of the present disclosure;

FIG. 3 is a diagram illustrating an exemplary first user interface rendered on a client device, in accordance with an embodiment of the present disclosure;

FIG. 4 is a flow diagram depicting operations to create a sub-skill of an executable workflow model, in accordance with an embodiment of the present disclosure; and

FIG. 5 is a flowchart of a method for generation of an executable logic of the first sub-skill, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF THE DISCLOSURE

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

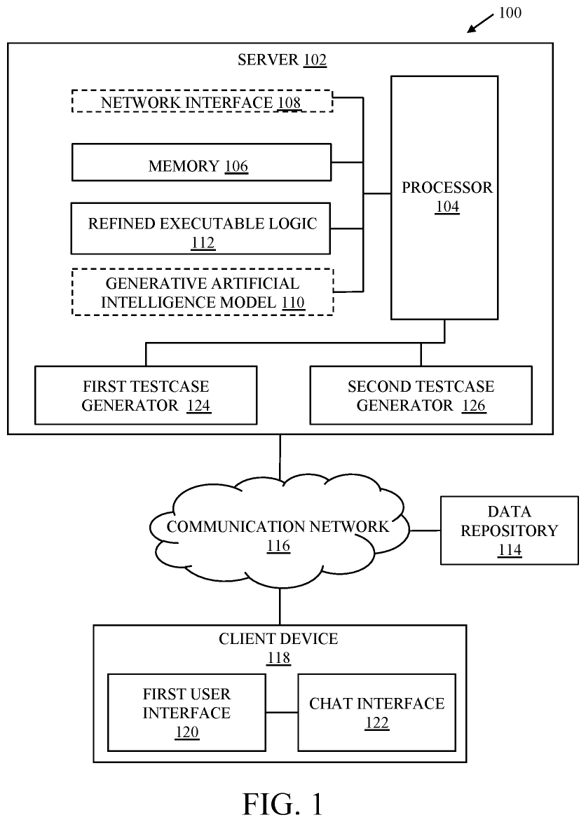

FIG. 1 is a block diagram illustrating a system for generation of an executable logic of a first sub-skill, in accordance with an embodiment of the present disclosure. With reference to FIG. 1, there is shown a block diagram of a system 100. The system 100 includes a server 102, a processor 104, a memory 106, a network interface 108 and a generative artificial intelligence (AI) model 110. The processor 104 is communicatively coupled with the memory 106. The processor 104 is further communicatively coupled with the network interface 108 and the generative AI model 110. Moreover, the system 100 is used to generate a refined executable logic 112 of a first sub-skill via the processor 104 based on an input including goal information to achieve the first sub-skill, and requirement information to achieve the goal for the first sub-skill.

In an implementation, the processor 104 and the memory 106 may be implemented on a same server, such as the server 102. In another implementations, the processor 104, the memory 106, the network interface 108 and the generative artificial intelligence (AI) model 110 may be implemented on the same server, such as the server 102. The network interface 108 is configured to communicate with the processor 104 and the memory 106. In some implementations, the server 102 is communicatively coupled with a data repository 114, a communication network 116. The server 102 may be communicatively coupled to a plurality of client devices, such as a client device 118, via the communication network 116. There is further shown a first user interface 120 and a chat interface 122 that may be linked to the first user interface 120 rendered on the client device 118.

The present disclosure provides the system 100 for generation of the refined executable logic 112 of the first sub-skill, where the system 100 receives the input including the dynamically generated goal and requirement information. The system 100 utilizes a machine-readable meta-plan based on this input and iteratively refines the initial logic through validation operations. The term “machine-readable meta-plan” refers to a structured and formatted representation of a plan or set of instructions that a computer system can interpret and execute. In the context of the present disclosure, the machine-readable meta-plan is designed to guide the generation of executable logic for a specific sub-skill. Users interact with a user-friendly chat interface for review and potential modifications. In particular, the system 100 features the chat interface 122 allowing users to review and modify the received input, fostering collaboration and user control. The system 100 further utilizes one or more testcase generators that creates a set of test scenarios to validate the executable logic generated for the sub-skills. The one or more testcase generators produces diverse input-output pairs, covering a range of conditions and scenarios, ensuring comprehensive testing. This not only facilitates the detection of errors, inconsistencies, or unexpected behavior in the logic but also contributes to overall quality assurance and reliability. In an example, in the context of creating a sub-skill for language translation, the system 100 dynamically generates input outlining language-specific processing requirements. The iterative refinement process, driven by testing and user feedback, ensures the executable logic aligns with the specific sub-skill goals and dynamically changing requirements. This underscores the system's adaptability in diverse skill development scenarios.

The received input includes the goal information to achieve the first sub-skill, and the requirement information to achieve the goal for the first sub-skill. In some implementations, the received input further includes input types and descriptions encompassing data or information required to execute the logic successfully. Some examples of the input types of the received input includes textual data, numerical values, or other relevant information necessary for the first sub-skill. Further, the received input includes outcomes specified by the goal information that is utilized to produce the logic. This outlines the anticipated results or responses that align with the received goal information and the received requirement information. The expected outputs serve as benchmarks for a validation process during the testing phase.

The server 102 is configured to communicate with the client device 118 via the communication network 116. In an implementation, the server 102 may be a master server or a master machine that is a part of a data center that controls an array of other cloud servers communicatively coupled to it for load balancing, running customized applications, and efficient data management. Examples of the server 102 may include, but are not limited to a cloud server, an application server, a data server, or an electronic data processing device.

The processor 104 refers to a computational element that is operable to respond to and processes instructions that drive the system 100. The processor 104 may refer to one or more individual processors, processing devices, and various elements associated with a processing device that may be shared by other processing devices. Additionally, the one or more individual processors, processing devices, and elements are arranged in various architectures for responding to and processing the instructions that drive the system 100. In some implementations, the processor 104 may be an independent unit and may be located outside the server 102 of the system 100. Examples of the processor 104 may include but are not limited to, a hardware processor, a digital signal processor (DSP), a microprocessor, a microcontroller, a complex instruction set computing (CISC) processor, an application-specific integrated circuit (ASIC) processor, a reduced instruction set (RISC) processor, a very long instruction word (VLIW) processor, a state machine, a data processing unit, a graphics processing unit (GPU), and other processors or control circuitry.

The memory 106 refers to a volatile or persistent medium, such as an electrical circuit, magnetic disk, virtual memory, or optical disk, in which a computer can store data or software for any duration. Optionally, the memory 106 is a non-volatile mass storage, such as a physical storage media. Furthermore, a single memory may encompass and, in a scenario, and the system 100 is distributed, the processor 104, the memory 106 and/or storage capability may be distributed as well. Examples of implementation of the memory 106 may include, but are not limited to, an Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or CPU cache memory.

The network interface 108 refers to a communication interface to enable communication of the server 102 to any other external device, such as the client device 118. Examples of the network interface 108 include, but are not limited to, a network interface card, a transceiver, and the like.

The generative AI model 110 refers to an artificial intelligence model designed specifically for the purpose of generating content or creating new data based on patterns it has learned from existing information. The generative AI model 110 may be utilized for tasks such as natural language understanding (NLU) to interpret the received input and, in some case, a user input, natural language generation (NLG) to convert concepts into detailed plans, or other tasks relevant to the executable logic of the first sub-skill.

The refined executable logic 112 refers to the set of instructions, prompts, software tools or code generated by the system 100, particularly associated with the first sub-skill. The refined executable logic 112 encapsulates the sequence of tasks and operations outlined in the machine-readable meta-plan, translating the user-defined goals and requirements into executable commands. In the context of the present disclosure, the refined executable logic 112 represents the tangible implementation of the identified sub-skill, capable of being compiled and executed by a computer system. The refined executable logic 112 is generated by iterative refinement of a first executable logic through validation operations, ensuring alignment with the user's intentions and the specific criteria outlined in the goal and requirement information. The refined executable logic 112 is the tangible output of process of the system 100, designed to fulfill the user's defined objectives for the first sub-skill.

The data repository 114 refers to a centralized storage location where data is stored, managed, and organized in a structured manner. It serves as a centralized and secure storage facility for various types of data, allowing efficient retrieval, sharing, and management of information. In the iterative refinement process of the first executable logic, the data repository 114 functions as a centralized storage system designed to retain multiple versions or iterations of the logic for future reference. The data repository 114 ensures effective version control, maintaining a structured organization of different iterations of the first executable logic. Each stored version represents a historical record, offering insights into the evolution of the first executable logic over time. With a focus on collaborative development, the data repository 114 facilitates efficient collaboration among multiple contributors, enabling them to access, modify, and contribute to the refined executable logic 112 while maintaining consistency. Additionally, the data repository 114 serves as a safeguard by providing mechanisms for backup and recovery, ensuring that previous versions of the refined executable logic 112 can be retrieved if needed. Overall, the data repository 114 plays a pivotal role in enhancing the systematic management, version control, and collaborative aspects of the iterative refinement process, contributing to a robust and adaptable development environment.

The communication network 116 includes a medium (e.g., a communication channel) through which the client device 118 communicates with the server 102. The communication network 116 may be a wired or wireless communication network. Examples of the communication network 116 may include, but are not limited to, Internet, a Local Area Network (LAN), a wireless personal area network (WPAN), a Wireless Local Area Network (WLAN), a wireless wide area network (WWAN), a cloud network, a Long-Term Evolution (LTE) network, a plain old telephone service (POTS), a Metropolitan Area Network (MAN), and/or the Internet.

The client device 118 refers to an electronic computing device operated by a user. The client device 118 comprises the first user interface 120 and the chat interface 122 linked to the first user interface 120. The first user interface 120 is configured to show the received input. In some examples, the first user interface 120 is configured to receive feedback on the input from at least one user. The chat interface 122 is linked to the first user interface 120 and is configured to receive a first user feedback on the elaborate plan. The client device 118 may be configured to obtain a user input in a natural language in a dialog box rendered over the first user interface 120 and communicate the user input to the server 102. The server 102 may then be configured to generate the refined executable logic 112. Examples of the client device 118 may include but not limited to a mobile device, a smartphone, a desktop computer, a laptop computer, a Chromebook, a tablet computer, a robotic device, or other user devices.

It should be understood by one of the ordinary skills in the art that the operations of the system 100 are explained by using a single client device. However, the operation of the system 100 is equally applicable for a number of user queries received from thousands to millions of client devices, where user requests are processed in parallel.

In operation, the processor 104 is configured to receive the input comprising the goal information to achieve the first sub-skill, and the requirement information to achieve the goal for the first sub-skill. In some implementations, the processor 104 is configured to receive the input comprising the goal information, the requirement information, input types and descriptions, and the outcomes specified by the goal information and the requirement information. In some examples, the input is provided by a workflow creator/producer. However, in some other examples, the input is autogenerated by a processor based on a description provided by the workflow creator/producer. In some implementations, the processor 104 is configured to receive the input from another sub-skill from a component of the system 100. In such implementation, an output of another sub-skill serves as valuable information or instructions for the first sub-skill, providing it with context or data necessary for its own logic generation. This sequential handoff of information between sub-skills allows the system 100 to tackle complex tasks by breaking them down into more manageable and specialized components.

The processor 104 is further configured to generate a machine readable meta-plan based on the received input. The machine readable meta-plan is indicative of a set of sequential tasks that define a sequence of tasks and interdependencies required to accomplish a goal defined in the goal information. The generation process involves parsing and analyzing the input, breaking down overarching objectives into manageable tasks, and leveraging a sequence of steps or actions to achieve a specific objective or goal or to devise a logical sequence. By structuring the machine readable meta-plan in a machine-readable format, the processor 104 ensures that subsequent components of the system 100 can interpret it accurately. This systematic approach not only facilitates the coherence and efficiency of the logic generation process but also allows for dynamic adaptation based on iterative feedback, optimizing the overall performance and responsiveness of the system 100 to user-defined tasks. In essence, the machine-readable meta-plan serves as a guiding framework, ensuring that the generated logic aligns precisely with the user's intentions and follows a well-defined sequence of tasks.

In some implementations, the processor 104 is further configured to retrieve data from a communication channel to identify relevant information to generate the first executable logic. The term “communication channel” refers to a pathway or medium through which information is exchanged between two or more entities, such as between different components of a system, devices, or individuals. In the context of the system 100 of the present disclosure, the processor 104 retrieves data from the communication channel, this may involve accessing information from various sources, which may include databases, APIs (Application Programming Interfaces), external systems, or other connected components. In some examples, the processor 104 understands the goal information and the requirement information of the first sub skill and generate a preliminary meta plan, via a planner tool. Further, the processor 104 scrutinizes the preliminary meta plan to identify any potential shortcomings, inconsistencies, or areas for improvement, via a critique tool. Furthermore, the processor 104 explores documentation on external systems or the Internet to identify relevant information that may address any shortcomings, inconsistencies, or areas for improvement. This exploration aims to assist in generating the first executable logic more efficiently, based on the preliminary meta-plan, using an explorer tool.

In such implementations, the processor 104 is further configured to utilize the identified relevant information to iteratively refine the machine readable meta-plan until an iteration has a higher relevancy of the first sub-skill than that of previous iterations. Specifically, iterative refinement mentioned above is driven by the aim of achieving the higher relevancy for the first sub-skill with each iteration compared to the relevancy in previous iterations. Higher relevancy corresponds to an increased alignment or suitability of the machine-readable meta-plan with the requirements information and the goal information associated with the first sub-skill.

In an example, in a first iteration, the planner tool is responsible for generating the preliminary machine-readable meta-plan based on the input received, which includes goal information and requirement specifications. The planner tool analyzes the input data to outline a set of sequential tasks and their interdependencies required to achieve the defined goal. It structures the meta-plan in a format that can be easily interpreted by the system for further processing. Further, the critique tool follows the generation of the meta-plan and involves a critical examination of its content. Here, the preliminary meta-plan is thoroughly scrutinized to identify any potential shortcomings, inconsistencies, or areas for improvement. Feedback and questions are raised based on the analysis, aiming to refine and enhance the clarity and effectiveness of the preliminary meta-plan. The critique tool serves as a quality control mechanism to ensure that the generated meta-plan aligns accurately with the intended goals and requirements. At last, the explorer tool comes into play, tasked with retrieving additional relevant information. The explorer tool accesses various sources, such as the internet or internal data repositories, to gather supplementary data that can address the questions and feedback raised by the critique tool. The explorer tool operates based on the set of questions posed in the previous stage, seeking to enrich the meta-plan with additional insights and details. Following the gathering of relevant information by the explorer tool and the feedback provided by the critique tool, the planner tool undertakes the task of updating the meta-plan. The planner tool incorporates the received feedback, along with the newly retrieved information, into the existing machine-readable meta-plan from the first iteration. The updated meta-plan reflects the iterative refinement process, aiming to enhance the accuracy, completeness, and effectiveness of the overall plan. This cyclic process of the machine readable meta-plan generation continues iteratively until the critique tool no longer provide significant suggestions or areas for improvement, indicating the completion of the refinement process.

The processor 104 is further configured to generate a first executable logic based on the generated machine readable meta-plan. Specifically, the processor 104 is endowed with the capability to translate the machine-readable meta-plan into a functional and executable solution by generating the first executable logic In some examples, the first executable logic may include a text, a multimodal prompt, a code, an external tool or combination thereof. In essence, the process of generating the first executable logic involves converting the abstract sequence of tasks and interdependencies outlined in the meta-plan into concrete, machine-readable code. The processor 104 interprets the machine readable meta-plan to understand specific requirements, input types, and desired outcomes, tailoring the generated logic accordingly. In some examples, the processor 104 may interpret the machine readable meta-plan using the generative AI model 110. The generation of the first executable logic is integral for prepared of the system 100 for execution, serving as a practical implementation of the user's high-level goal. It bridges the conceptual divide between planning and execution, allowing the system 100 to autonomously carry out tasks in alignment with the user's intentions. This phase sets the foundation for automation, facilitating the efficient and precise execution of tasks specified for the first sub-skill.

The processor 104 is further configured to iteratively refine the generated first executable logic to obtain the refined executable logic 112 based on a validation operation. In the validation operation, when the first executable logic is executed, an output dataset is generated and compared with an outcome specified by the goal and the requirement information such that in each iteration of the refinement of the generated first executable logic, one or more errors or inconsistencies in the first executable logic is removed. In other words, the processor 104 engages in an iterative refinement process to enhance the quality and precision of the initially generated first executable logic. This iterative cycle involves running the validation operation, where the processor 104 compares the output dataset produced during execution with the expected outcomes specified by user-defined goals and requirements, via a debugger tool. If the validation operation fails, the debugger tool serves as a critical checkpoint, identifying errors or inconsistencies in the first executable logic. Subsequently, the processor 104 generates a feedback from the validation operation, suggesting adjustments and corrections to the initially generated first executable logic, via the debugger tool. Later, the feedback is passed to the planner tool for further refinement. This iterative loop of refinement, feedback incorporation, and re-execution continues until the refined executable logic 112 consistently aligns with the user's objectives and requirements. The process not only enables error detection and correction but also facilitates dynamic adaptation, ensuring that the system 100 evolves in response to changing sub-skill demands or user expectations. Through this iterative refinement, the processor 104 ensures that the refined executable logic 112 is not only accurate but also continuously optimized for improved performance and effectiveness in achieving the specified sub-skill.

In some implementations, in order to iteratively refine the generated first executable logic, the processor 104 is further configured to revise the first executable logic by incorporating a feedback from the validation operation and re-executing the validation operation. In such implementations, the iterative refinement process of the generated first executable logic involves a systematic feedback loop orchestrated by the processor 104. Following each iteration of the validation operation, the processor 104 analyzes the results and incorporates feedback obtained during the validation operation. This feedback, which may include detected errors, inconsistencies, or areas for improvement, serves as valuable insights for refining the first executable logic. In response to this feedback, the processor 104 revises the first executable logic, making necessary adjustments to address identified issues. The revised executable logic then undergoes a subsequent iteration of the validation operation, wherein its performance is re-evaluated. This iterative cycle of revision, feedback incorporation, and re-execution continues until the executable logic achieves a state where it consistently meets the specified goals and requirements. The iterative refinement process ensures a dynamic and adaptive approach, allowing the system 100 to progressively enhance the precision, correctness, and efficiency of the first executable logic in alignment with user-defined objectives.

In an example, consider a sub-skill designed to automate the task of sorting and organizing a collection of digital files is to be generated using the system 100. The processor 104 of the system 100 receives an input that includes the goal information, such as sorting files by file type and organizing them into specific folders, along with requirement information detailing the desired file organization structure. The processor 104 then generates a machine-readable meta-plan based on this input. The meta-plan outlines a sequence of tasks, including identifying file types, creating folders, and arranging files accordingly. The interdependencies are captured in the meta-plan, ensuring a logical flow of tasks to achieve the specified goal. With the machine-readable meta-plan in place, the processor 104 generates the first executable logic. This logic includes instructions for the system to execute tasks like file scanning, folder creation, and file relocation based on the defined criteria. However, in the initial stages, this logic may have imperfections or errors. To address these issues, the system 100 initiates an iterative refinement process. During the validation operation, the first executable logic is executed, leading to the generation of an output dataset. This output dataset, representing the organized files, is then compared with the expected outcome specified by the user's goal and requirement information.

In another example, if the goal was to organize image files into separate folders by file type, the validation operation checks whether the actual output matches this expected outcome. Any discrepancies, such as misclassified files or folder structure errors, are identified. The processor 104 then iteratively refines the first executable logic based on this feedback, correcting errors and improving the logic's accuracy. In subsequent iterations, the refined executable logic is re-executed, and the validation process is repeated. This iterative cycle continues until the system 100 consistently organizes files according to the user's goals, removing errors or inconsistencies in each refinement iteration. The result is the refined executable logic 112 that accurately fulfills the specified sub-skill of organizing digital files based on user-defined criteria.

In some implementations, the processor 104 is further configured to generate a set of testcases based on the first sub-skill to test and validate the first executable logic. Each of the set of testcases includes an input-output pair based on the first sub-skill. By generating the set of test cases, the processor 104 ensures a thorough examination of various potential inputs and corresponding expected outputs associated with the first sub-skill. This testing approach aims to uncover potential vulnerabilities, edge cases, or inaccuracies in the logic, providing a robust mechanism for validation. For example, in the context of a system designed for natural language processing, the processor 104 may generate test cases that encompass a range of linguistic nuances and user inputs. The linguistic nuances and user inputs may include variations in sentence structure, vocabulary, or contextual nuances relevant to the specific sub-skill. The input-output pairs within the test cases serve as benchmarks against which the system's performance is assessed, ensuring that the executable logic consistently produces accurate and desired outcomes across diverse scenarios.

In some implementations, the system 100 further includes a first testcase generator 124. One or more primary testcases of the set of testcases are generated by the processor 104 using the first testcase generator 124. The first testcase generator 124 generates a set of first input-output pairs without accessing the generated executable logic. In some implementations, the first testcase generator 124 refers to a “Black Box Test Case Generator” that is a tool or component within a testing framework that is designed to automatically create test cases for black-box testing. Black-box testing is an approach where the tester examines functionality of the system 100 without detailed knowledge of its internal code or implementation. The first testcase generator 124 uses input specifications, requirements, or functional descriptions to create test cases that assess external behavior of the system 100, focusing on inputs and expected outputs without delving into the internal logic or structure of the software. The goal is to validate functionality of the system 100, adherence to specifications, and its ability to handle various inputs and scenarios. In an example, if the problem statement is “Question answering system”, the one or more primary testcases may include:

### Testcase 1:

input—Who is the president of USA?
output—Joe Biden

In some other implementations, the system 100 includes a second testcase generator 126. One or more secondary testcases of the set of testcases are generated by the processor 104 using the second testcase generator 126. The second testcase generator 126 generates a set of second input-output pairs while accessing the generated executable logic. The second testcase generator 126 refers to a “White Box Test Case Generator” that is a tool or component within a testing framework that is designed to automatically create test cases for white-box testing. White-box testing is an approach where the tester has detailed knowledge of the internal code, logic, and structure of the software being tested. The second testcase generator 126 uses this knowledge to create test cases that assess the correctness of individual components, paths, and internal operations within the software. The second testcase generator 126 may focus on ensuring that all code statements are executed, all decision branches are taken, and specific conditions are met within the code. The goal of white-box testing is to validate the internal logic and structure of the software, ensuring that it functions as intended at the code level. The generated test cases for white-box testing often target specific code paths, conditions, and branches to uncover potential errors or weaknesses in the implementation.

In some implementations, the one or more primary testcases are generated only once whereas the one or more secondary testcases are generated for each iteration. The one or more primary test cases are generated only once, at the initial phase, and remain consistent throughout the subsequent iterations of the refinement process. The one or more primary testcases serve as foundational benchmarks for evaluating the performance and correctness of the first executable logic. On the other hand, the one or more secondary testcases are dynamically generated for each iteration of the refinement process. Unlike the primary test cases, the secondary test cases are responsive to the evolving nature of the first executable logic. This adaptability allows the system 100 to address potential edge cases, corner scenarios, or specific conditions that may arise during the refinement iterations. The dynamic generation of the one or more secondary test cases enhances the testing robustness, ensuring that the first executable logic is continually evaluated against a diverse set of scenarios, contributing to a more comprehensive and effective refinement process.

In some implementations, a first iteration of the validation operation has a first relevance to the first sub-skill and a second iteration of the validation operation has a second relevance to the first sub-skill. The second relevance is higher than the first relevance. In such implementations, an iterative refinement process of the first executable logic introduces a concept of relevance, wherein subsequent iterations of the validation operation hold a higher degree of refinement compared to earlier iterations. Initially, during the first iteration of the validation operation, the system 100 evaluates the performance of the first executable logic concerning the specified goals and requirements for the first sub-skill. As the refinement process progresses, subsequent iterations are assigned a higher relevance, indicating an increased emphasis on feedback and results obtained from later cycles. This hierarchical approach acknowledges accumulative learning of the system 100 and growing understanding of the first sub-skill nuances over multiple refinement cycles. By prioritizing later iterations with higher relevance, the system 100 adapts to evolving requirements and ensures continuous improvement, ultimately aiming for a more mature and optimized executable logic (i.e., the refined executable logic 112).

In some implementations, the processor 104 is further configured to receive a first user feedback on the refined executable logic in a natural language via the chat interface 122 coupled to the system 100. The processor 104 is further configured to regenerate the machine-readable meta-plan based on the goal information and the requirement information of the first sub-skill and the received first user feedback. The incorporation of the chat interface 122 aims to democratize the feedback process, allowing users, even those without extensive technical backgrounds, to express their opinions and insights regarding performance of the system 100. The users may share observations, suggestions, or concerns about the refined executable logic in a conversational and accessible manner. Upon receiving the first user feedback in the natural language through the chat interface 122, the processor 104 utilizes the first user feedback alongside the goal information and the requirement information associated with the first sub-skill. Subsequently, the processor 104 dynamically regenerates the machine-readable meta-plan, adapting it based on the user's input to enhance the overall logic generation process. The above mentioned feedback loop allows users to contribute to improvement of the system 100 by providing insights into how well the refined executable logic 112 aligns with the goal information and the requirement information. Moreover, the regeneration of the machine readable meta-plan reflects agility of the system 100 in responding to the first user feedback, ensuring that subsequent iterations are informed by user experiences and preferences. This iterative refinement based on the first user feedback contributes to a more user-centric, adaptive, and effective system over time.

The disclosed system 100 and associated implementations introduces a processor driven approach. Through the processor-driven approach, the system 100 automates the generation of executable logic for a targeted sub-skill, significantly reducing manual effort. The creation of the machine-readable meta-plan provides a structured representation of tasks and interdependencies, enhancing interpretability and execution accuracy of the system 100. Further, the system 100 has the iterative refinement process, systematically addressing errors or inconsistencies in each iteration, ensuring a continuous improvement in logic accuracy. The validation operation, involving output dataset comparison with specified goals, guarantees correctness and expected outcomes. Adaptability of the system 100 is evident through the chat interface 122, allowing the users to provide natural language feedback. The processor 104 dynamically regenerates the machine readable meta-plan based on the user feedback, creating an adaptive and user-centric system. Comprehensive testing, facilitated by the generation of specific test cases, ensures resilience and reliability. In essence, this embodiment amalgamates automation, iterative enhancement, adaptive feedback, and robust testing, resulting in a highly efficient and accurate system for executable logic generation tailored to specific sub-skills.

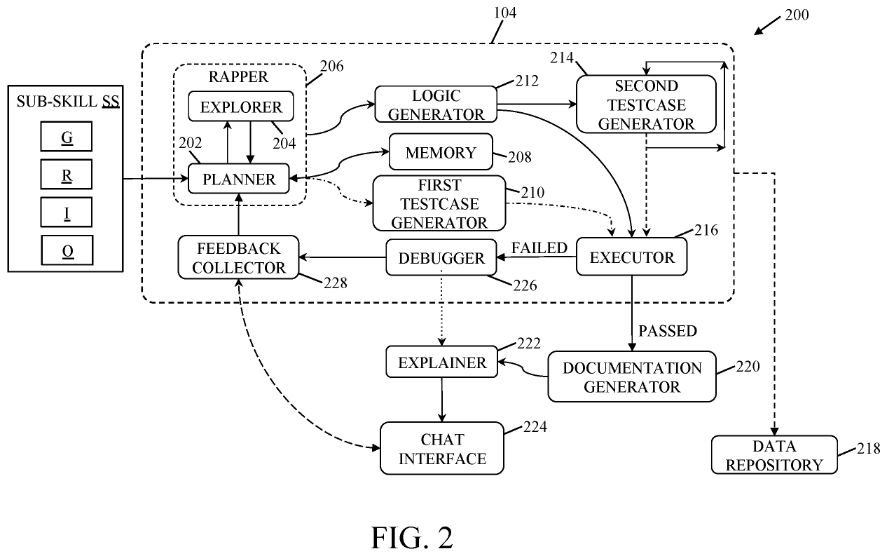

FIG. 2 is a flow diagram illustrating operations of the system for generation of the executable logic of the first sub-skill, in accordance with an embodiment of the present disclosure. FIG. 2 is described in conjunction with the elements of FIG. 1. With reference to FIG. 2, there is shown a flow diagram 200 for generation of the executable logic of the first sub-skill. The flow diagram 200 includes a series of operations 202 to 228. The operations 202 to 218 are performed by the processor 104.

At operation 202, the planner comprehends the received input and utilizes the received input to guide the generation of the machine readable meta-plan. The received input includes the goal information G to achieve the first sub-skill SS, the requirement information R to achieve the goal for the first sub-skill SS, input types and descriptions I, and the outcomes O. Based on the received input, the planner generates the machine-readable meta-plan, which outlines a sequence of tasks and interdependencies necessary to achieve the specified goals in the goal information G.

At operation 204, the explorer is configured to actively search and retrieve information from diverse sources, such as documentation or the internet. The explorer scours these sources to identify data, code snippets, prompts, or other relevant content related to the first sub-skill SS and the goal information G. Once information is retrieved, the explorer analyzes and explores the data to understand its relevance and potential utility in achieving the goal information G and the requirement information R associated with the first sub-skill SS. This process involves parsing and interpreting diverse data types to extract meaningful insights.

At operation 206, the planner and the explorer of the retrieval augmentation planner work in tandem to iteratively refine the preliminary meta-plan to generate the machine readable meta plan. The explorer contributes insights gained from information retrieval, and the planner uses this feedback to enhance the preliminary meta-plan until predefined conditions (i.e., the goal information G, the requirement information R, the input types and description I, and the outcomes O) for the first sub-skill SS are satisfied.

At operation 208, the generated machine readable meta plan is stored in the memory 106 (shown in FIG. 1). Moreover, the preliminary meta plan and the previous revisions on the preliminary metal plans are also stored in the memory 106 in-order track or avoid re-doing it. Consequently, at operation 210, the one or more primary testcases are generated by the first testcase generator 124. Specifically, the first testcase generator 124 generates the set of input/output pairs based on the input received to achieve the first subskill SS to test the first executable logic. However, the first testcase generator 124 doesn't have access to how the first executable logic works. In some examples, the user may also provide the one or more primary testcases manually. In some other examples, the one or more primary testcases may be propagated from previously generated sub-skills.

At operation 212, the processor 104 generates the first executable logic based on the machine readable meta plan. In some examples, the first executable logic may include a prompt, code, tool or combination thereof. After that, at operation 214, the one or more secondary testcases are generated by the second testcase generator 126. The second testcase generator 126 have access to the first executable logic and creates the one or more secondary testcases to detect any edge cases issues. Here, the edge cases issues implies identifying and addressing potential problems or abnormalities that may arise when the input values are at the edges or extremes of what the system 100 (of FIG. 1) may handle. For example, if a program is designed to accept numerical inputs, testing edge cases might involve assessing how the system behaves when given the smallest possible number, the largest possible number, or even non-numeric inputs. Similarly, for a time-based application, edge cases might involve testing how the system 100 responds to dates very close to the current date or far in the future.

Further, at operation 216, the processor 104 executes the first executable logic on each generated testcase i.e., the one or more primary testcases and the one or more secondary testcases, via an executor. Furthermore, at operation 218, the first executable logic is stored in the data repository 114. Also, other versions of the first executable logic generated by iteratively refining the first executable logic based on any kind of feedback are also stored in the data repository 114.

If the first executable logic passes successfully on both the primary and secondary testcases upon execution, the system 100 proceeds to operation 220. Upon successful execution of the first executable logic on the primary and secondary testcases, at operation 220, a documentation generator is configured to compile a comprehensive documentation set, encapsulating various aspects of the generated first executable logic. The comprehensive documentation set encompasses details about the machine readable meta-plan, logic functionalities, input-output specifications, usage instructions, and implementation notes. After that, at operation 222, an explainer component is configured to provide additional insights and detailed explanations of the comprehensive document set. The explainer component aims to explain complex algorithms, decision-making processes, key design choices, and address potential user queries. Together, operations 220 and 222 ensure a transparent and well-documented system, fostering clarity and facilitating successful implementation and collaboration among stakeholders. In some implementations, the server 102 of the system 100 includes the documentation generator and the explorer component. After that, at operation 224, an output of the explainer component, i.e., the generated first executable logic, associated documentation, and explanatory details, is presented on the chat interface 122. This user-facing step allows individuals to directly interact with the generated executable logic, explore functionalities, and review provided documentation. The users gain an in-depth understanding of the logic's inner workings. Importantly, operation 224 provides a platform for the users to offer their initial feedback, sharing insights, comments, or suggestions about the logic's usability and effectiveness.

Further, if the first executable logic fails on either of the one or more primary testcases and the one or more secondary testcases upon execution, the system 100 proceeds to operation 226. At operation 226, the debugger initiates an automated feedback loop. The debugger systematically investigates the encountered errors, inconsistencies, or unexpected outcomes, aiming to identify the root causes leading to failure during the execution of the one or more primary testcases and the one or more secondary testcases with the first executable logic. By identifying the root causes, the debugger provides valuable insights into areas that require refinement or correction within the first executable logic. This iterative process ensures that the subsequent versions of the first executable logic address and rectify the underlying issues, contributing to the continuous improvement of the system 100.

At operation 228, the processor 104 receives the first user feedback from the users via the chat interface 122 and then further understands the first user feedback and devise a step-by-step plan to incorporate the first user feedback. In addition, at operation 228, the processor 104 further receives a refined version of the first executable logic. Moreover, the step-by-step plan to incorporate the first user feedback and the refined version of the first executable logic is shared to the planner to generate the refined executable logic 112.

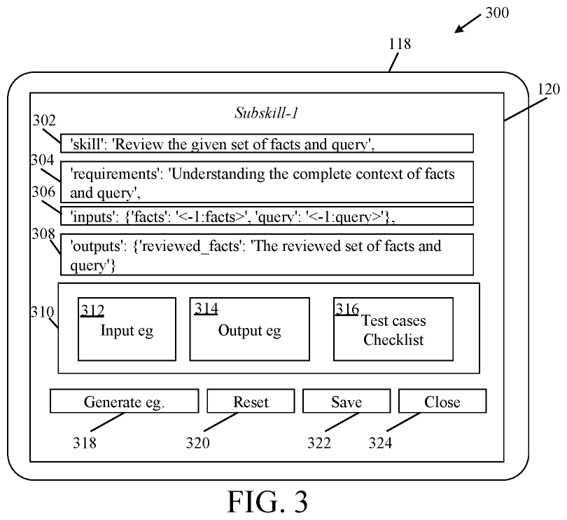

FIG. 3 is a diagram illustrating a first user interface displaying a first sub-skill, in accordance with an embodiment of the present disclosure. FIG. 3 is described in conjunction with the elements of FIGS. 1 and 2. With reference to FIG. 3, there is shown an exemplary schematic diagram 300 of the client device 118 on which the first user interface 120 is rendered. In the illustrated embodiment of FIG. 3, the first user interface 120 showing a dialog box for a subskill-1 and includes a skill block 302, a requirement block 304, an input block 306, an output block 308, and an example block 310. Different blocks on the first user interface 120 are designated for skills, requirements, input, output, and example generation. For example, the skill block 302 includes the skill information, the requirement block 304 includes the requirement information, the input block 306 includes the input types and corresponding description, and the output block 308 includes the outcomes. The example block 310 includes an input examples button 312 and an output examples button 314 for inputting examples manually. The example block 310 further includes a test cases checklist button 316 that allows to see a list testcases on being clicked. The first user interface 120 further includes a generate example button 318 for generating examples using the subskill-1, a reset button 320 to reset the subskill-1, a save button 322 to save the subskill-1 and generated examples and testcases, and a close button 324 for closing the dialog box of the sub-skill-1.

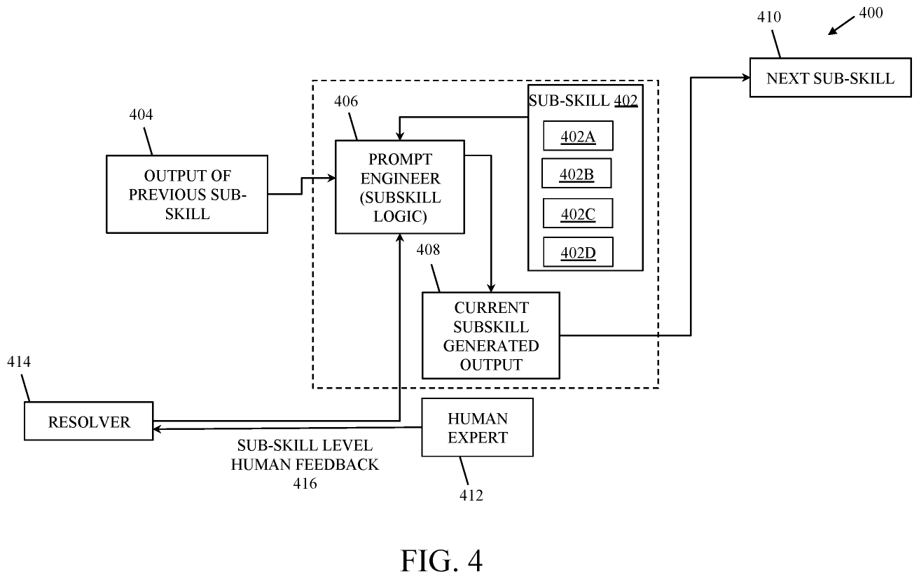

FIG. 4 is a flow diagram depicting operations to create a sub-skill of an executable workflow model, in accordance with an embodiment of the present disclosure. FIG. 4 is described in conjunction with the elements of FIGS. 1, 2, and 3. With reference to FIG. 4, there is shown a flow diagram 400 to create a sub-skill 402. In some implementations, the sub-skill 402 is a part of an executable workflow model. In such executable workflow model, two or more than two sub-skills can be connected through a logical flow or sequence that represents the order in which they are executed or the dependencies between them. The flow diagram 400 includes a series of operations 404 to 414. The operations 404 to 414 are performed by the processor 104.

At operation 404, a validated output of a previous sub-skill is received as input for the sub-skill 402 to be generated. After that, at operation 406, the validated output of the previous sub-skill is received by a prompt engineer module. The prompt engineer module generates the prompt to generate an outcome 402D of the sub-skill 402 based on the validated output of the previous sub-skill received as the input and a goal information 402A, a requirement information 402B, an input type information 402C of the sub-skill 402. After that, at operation 408, the processor 104 is further configured to generate the outcome 402D of the sub-skill 402. Further, at operation 410, a sub-skill subsequent to the sub-skill 402 receive the outcome 402D of the sub-skill 402 as an input. For example, to generate another sub-skill consequently connected to the sub-skill 402 in the logical flow, an output of the sub-skill 402 is received by the prompt engineer module as the input and then an outcome of the connected sub-skill is shared to generate yet another sub-skill consequently attached to previous sub-skill in the logical flow. Later, at operation 412, the processor 104 is further configured to receive a user feedback from the human expert or the end user. The user feedback includes a sub-skill level human feedback 416. The sub-skill level human feedback 416 is further elaborated by the resolver at operation 414. Further, the elaborated sub-skill level human feedback 416 is implemented by the prompt engineer module at the operation 406. This is done to refine the prompt generated based on the third user feedback.

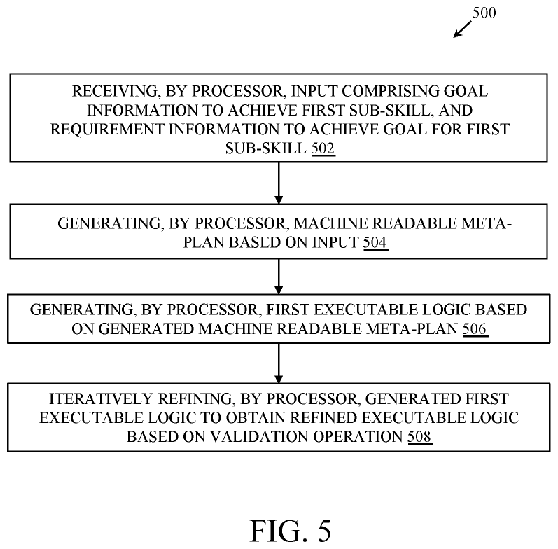

FIG. 5 is a flowchart of a method for generation of an executable logic of the first sub-skill, in accordance with an embodiment of the present disclosure. FIG. 5 is described in conjunction with the elements of FIGS. 1 to 4. With reference to FIG. 5, there is shown a method 500 for generation of an executable logic of the first sub-skill. The method 500 includes steps from 502 to 508.

At step 502, the method 500 includes receiving, by the processor 104, the input including goal information to achieve the first sub-skill, and requirement information to achieve the goal for the first sub-skill. By capturing comprehensive requirement details, the method 500 lays the groundwork for a structured and purposeful approach to generating executable logic. The received input allows for adaptability, accommodating variations in sub-skills, and fostering customization based on unique requirements. Additionally, the method 500 provides the flexibility to integrate user-defined input, promoting collaboration and inclusiveness in the logic generation process. Further, this may establish a strong and tailored foundation, enhancing the efficiency, accuracy, and relevance of the first executable logic generated for the specified sub-skill.

At step 504, the method 500 further generating, by the processor 104, the machine readable meta-plan based on the input. The machine readable meta-plan is indicative of a set of sequential tasks that define a sequence of tasks and interdependencies required to accomplish a goal defined in the goal information. Firstly, the machine readable meta plan provides a well-organized and sequential representation of tasks needed to achieve the specified goal, ensuring a logical workflow. This structured approach enhances the method's efficiency. The meta-plan also excels in recognizing how tasks depend on each other, contributing to a cohesive workflow. Additionally, being machine-readable allows for smoother integration with computational processes, reducing the likelihood of errors and speeding up task execution. The goal-centric nature of the meta-plan means that each task directly contributes to achieving the overarching goal. Furthermore, its adaptability allows it to accommodate different sub-skills, making the method versatile and applicable in various contexts. As a foundational element, the meta-plan sets the stage for iterative refinement, allowing for continuous improvement in subsequent iterations.

At step 506, the method 500 further includes generating, by the processor 104, the first executable logic based on the generated machine readable meta-plan. The technical advantage lies in the systematic generation of the first executable logic by the processor 104 based on the generated machine-readable meta-plan. This process ensures a direct and coherent translation of the planned sequential tasks into actionable code or instructions. The generated executable logic maintains close alignment with the structured workflow defined in the meta-plan, fostering consistency and reducing the risk of misalignment. This direct translation from plan to logic promotes efficiency in implementing tasks, avoiding interpretation gaps and streamlining the conversion of planned actions into executable instructions. Moreover, the step minimizes ambiguity and misinterpretation in the translation process. The machine-readable nature of the meta-plan serves as a clear and unambiguous guide, contributing to the reduction of errors during the generation of the first executable logic. The systematic generation also facilitates automation in subsequent stages, accelerating the overall process and reducing the need for manual intervention. Adhering to the goal-centric approach established by the machine readable meta-plan, the generated first executable logic is purposefully designed to contribute to the achievement of the specified goal, ensuring alignment with overarching objectives. Furthermore, the direct relationship between the machine readable meta-plan and the first executable logic enhances the readability and maintainability of the generated code. This clarity simplifies debugging, modification, and future enhancements to the logic, contributing to a more robust and adaptable system.

At step 508, the method 500 further includes iteratively refining, by the processor 104, the generated first executable logic to obtain the refined executable logic 112 based on the validation operation. In the validation operation, when the first executable logic is executed, the output dataset is generated and compared with an outcome specified by the goal and the requirement information such that in each iteration of the refinement of the generated first executable logic, one or more errors or inconsistencies in the first executable logic is removed. In some implementations, the iteratively refining of the generated first executable logic includes revising, by the processor 104, the first executable logic by incorporating the feedback from the validation operation and re-executing the validation operation. The iterative refinement process allows the identification of errors or inconsistencies in the logic, ensuring alignment with the intended outcomes. Further, the iterative refinement process capitalizes on the insights gained from each validation iteration. By revising the executable logic based on the feedback from the validation operation and subsequently re-executing the validation, the processor 104 systematically addresses and eliminates identified errors. This iterative approach contributes to the continuous improvement of the logic, refining its accuracy and reliability with each iteration. Furthermore, this iterative refinement mechanism provides a dynamic and adaptive framework. It accommodates evolving requirements, unforeseen challenges, and changing goals, ensuring that the generated first executable logic remains resilient and responsive to variations in the task environment.

In some implementations, the method 500 further includes receiving, by the processor 104, the input from another sub-skill connected to the first sub-skill in a logical flow. By establishing a logical flow between sub-skills, the processor 104 allows a cohesive exchange of information within a structured framework. This approach enables the processor 104 to receive relevant input from interconnected sub-skills, creating a synergistic relationship. The technical advantage lies in the seamless integration of information and input from related sub-skills connected in a logical flow, fostering a more holistic understanding of the task at hand.

In some implementations, the method 500 further includes generating, by the processor 104, the set of testcases based on the first sub-skill to test and validate the first executable logic. Each of the set of testcases includes the input-output pair based on the first sub-skill. The one or more primary testcases of the set of testcases are generated by the processor 104 using a first testcase generator 124. The first testcase generator 124 generates a set of first input-output pairs without accessing the generated executable logic. The one or more secondary test cases of the set of testcases are generated by the processor 104 using the second testcase generator 126. The second testcase generator 126 generates the set of second input-output pairs while accessing the generated first executable logic. By combining both the primary and secondary testcases, the method 500 establishes a robust testing framework. This dual-generator approach ensures a thorough examination of the executable logic's capabilities under various conditions, enhancing reliability and resilience of the method 500. The technical advantage lies in the meticulous testing strategy that balances isolated scenarios with real-world interactions, contributing to a more comprehensive validation process for the generated executable logic.

In some implementations, the method 500 further includes receiving, by the processor 104, the first user feedback on the refined executable logic 112 in the natural language via the chat interface 122. The method 500 further includes regenerating, by the processor 104, the machine-readable meta-plan based on the goal information and the requirement information of the first sub-skill and the received first user feedback. By leveraging a chat interface, users can provide feedback in a more intuitive manner. The ability of the processor 104 to interpret and incorporate this feedback into the regeneration of the machine-readable meta-plan enhances responsiveness of the first sub-skill to user preferences and refinements. This iterative feedback loop promotes a user-friendly experience, allowing users to actively participate in shaping and improving the first sub-skill. The technical advantage thus lies in capacity of the subskill to understand and integrate the first user feedback expressed in the natural language, contributing to the continuous enhancement and customization of the first executable logic based on the first user feedback.

In some implementation, the method 500 further including retrieving, by the processor 104, data from the communication channel to identify relevant information to generate the first executable logic. The method 500 further including utilizing, by the processor 104, the identified relevant information to iteratively refine the machine readable meta-plan until an iteration has the higher relevancy of the first sub-skill than that of previous iterations. The processor 104, through this mechanism, retrieves relevant data to inform the generation of the first executable logic. By utilizing identified information, the processor 104 iteratively refines the machine-readable meta-plan, progressively enhancing the relevancy of the first sub-skill with each iteration. The technical advantage lies in proactive approach of the method 500 to information gathering and refinement. Leveraging the communication channel allows the processor 104 to stay dynamically informed, adapting its understanding based on real-time or periodically updated data. This iterative refinement process ensures that the machine-readable meta-plan evolves with the highest relevancy for the first sub-skill, enhancing the adaptability and responsiveness of the method 500 to changing conditions or input sources.

Modifications to embodiments of the present disclosure described in the foregoing are possible without departing from the scope of the present disclosure as defined by the accompanying claims. Expressions such as “including”, “comprising”, “incorporating”, “have”, “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A system, comprising:
a processor configured to:
receive an input comprising goal information to achieve a first sub-skill, and requirement information to achieve a goal for the first sub-skill;
generate a machine readable meta-plan based on the received input, wherein the machine readable meta-plan is indicative of a set of sequential tasks that define a sequence of tasks and interdependencies required to accomplish a goal defined in the goal information;
generate a first executable logic based on the generated machine readable meta-plan; and
iteratively refine the generated first executable logic to obtain a refined executable logic based on a validation operation,
wherein, in the validation operation, when the first executable logic is executed, an output dataset is generated and compared with an outcome specified by the goal and the requirement information such that in each iteration of a refinement of the generated first executable logic, one or more errors or inconsistencies in the first executable logic is removed.

2. The system of claim 1, wherein a first iteration of the validation operation has a first relevance to the first sub-skill and a second iteration of the validation operation has a second relevance to the first sub-skill, and wherein the second relevance is higher than the first relevance.

3. The system of claim 1, wherein the processor is configured to receive the input from another sub-skill from a component of the system.

4. The system of claim 1, wherein, in order to iteratively refine the generated first executable logic, the processor is further configured to revise the first executable logic by incorporating a feedback from the validation operation and re-executing the validation operation.

5. The system of claim 1, wherein the processor is further configured to generate a set of testcases based on the first sub-skill to test and validate the first executable logic, and wherein each of the set of testcases comprises an input-output pair based on the first sub-skill.

6. The system of claim 5, further comprising a first testcase generator, and wherein one or more primary testcases from the set of testcases are generated by the processor using the first testcase generator, and wherein the first testcase generator generates a set of first input-output pairs without accessing the generated first executable logic.

7. The system of claim 6, further comprising a second testcase generator, wherein a set of second testcases of the set of testcases are generated by the processor using the second testcase generator, and wherein the second testcase generator generates a set of second input-output pairs while accessing the generated executable logic.

8. The system of claim 1, wherein the processor is further configured to:
receive a first user feedback on the refined executable logic in a natural language via a chat interface coupled to the system; and
regenerate the machine-readable meta-plan based on the goal information and the requirement information of the first sub-skill and the received first user feedback.

9. The system of claim 1, wherein the processor is further configured to retrieve data from a communication channel to identify relevant information to generate the first executable logic.

10. The system of claim 9, wherein the processor is further configured to utilize the identified relevant information to iteratively refine the machine readable meta-plan until an iteration has a higher relevancy of the first sub-skill than that of previous iterations.

11. A method, comprising:
receiving, by a processor, an input comprising goal information to achieve a first sub-skill, and requirement information to achieve the goal for the first sub-skill;
generating, by the processor, a machine readable meta-plan based on the input, wherein the machine readable meta-plan is indicative of a set of sequential tasks that define a sequence of tasks and interdependencies required to accomplish a goal defined in the goal information;
generating, by the processor, a first executable logic based on the generated machine readable meta-plan; and
iteratively refining, by the processor, the generated first executable logic to obtain a refined executable logic based on a validation operation,
wherein, in the validation operation, when the first executable logic is executed, an output dataset is generated and compared with an outcome specified by the goal and the requirement information such that in each iteration of the refinement of the generated first executable logic, one or more errors or inconsistencies in the first executable logic is removed.

12. The method of claim 11, wherein a first iteration of the validation operation has a first relevance to the first sub-skill and a second iteration of the validation operation has a second relevance to the first sub-skill, and wherein the second relevance is higher than the first relevance.

13. The method of claim 11, wherein the method further comprising receiving, by the processor, the input from another sub-skill connected to the first sub-skill in a logical flow.

14. The method of claim 11, wherein, the iteratively refining of the generated first executable logic comprises revising, by the processor, the first executable logic by incorporating a feedback from the validation operation and re-executing the validation operation.

15. The method of claim 11, further comprising generating, by the processor, a set of testcases based on the first sub-skill to test and validate the first executable logic, and wherein each of the set of testcases comprises an input-output pair based on the first sub-skill.

16. The method of claim 15, wherein one or more primary testcases of the set of testcases are generated by the processor using a first testcase generator, and wherein the first testcase generator generates a set of first input-output pairs without accessing the generated executable logic.

17. The method of claim 16, wherein one or more secondary test cases of the set of testcases are generated by the processor using a second testcase generator, and wherein the second testcase generator generates a set of second input-output pairs while accessing the generated executable logic.

18. The method of claim 11, further comprising:
receiving, by the processor, a first user feedback on the refined executable logic in a natural language via a chat interface; and
regenerating, by the processor, the machine-readable meta-plan based on the goal information and the requirement information of the first sub-skill and the received first user feedback.

19. The method of claim 11, further comprising retrieving, by the processor, data from a communication channel to identify relevant information to generate the first executable logic.

20. The method of claim 19, further comprising utilizing, by the processor, the identified relevant information to iteratively refine the machine readable meta-plan until an iteration has a higher relevancy of the first sub-skill than that of previous iterations.
